(19) United States
(12) Patent Application Publication
(10) Pub. No.: US 2014/0338597 A1
(43) Pub. Date: Nov. 20, 2014

(54) Mask Plate for Glue Coating and Manufacturing Method Thereof

(71) Applicant: Shenzhen China Star Optoelectronics Technology Co., Ltd., Shenzhen, Guangdong (CN)

(72) Inventors: Jinchuan Li, Shenzhen City (CN); Tsungyuan Wu, Shenzhen City (CN)

(73) Assignee: Shenzhen China Star Optoelectronics Technology Co., Ltd., Shenzhen, Guangdong (CN)

(21) Appl. No.: 14/111,559

(22) PCT Filed: Jun. 28, 2013
(86) PCT No.: PCT/CN2013/078247

§ 371 Date: Oct. 13, 2013

(30) Foreign Application Priority Data
May 16, 2013 (CN) 201310182544.X

(51) Int. Cl. B05C 21/00

(52) U.S. Cl. CPC B05C 21/005
USPC 118/504; 29/428

(57) ABSTRACT

The present invention provides a mask plate for glue coating and the manufacturing method thereof. The mask plate includes a frame and a screen plate (20) installed on the frame. The screen plate (20) made of sheet metal includes an outer shield area (26), an inner shield area (24) and a plurality of skeletons (28) whose one side connecting with the inner shield (24) area and the other side connecting with the outer shield area (26), and the outer shield area (26), the inner shield area (24) and the skeletons (28) form a plurality of coating areas (22). The present invention adopts a screen plate, made of sheet metal, having coating areas and shield areas in one frame so that it not only prolongs the lifetime of the mask plate but also maintains a good appearance by preventing glasses from damage and cross marks during glue coating because the screen plate is in the same plane. Furthermore, it is capable of adjusting coating thickness by choosing different thick sheet metals to make the mask plate.

### BACKGROUND OF THE INVENTION

1. Field of the Invention

The present invention relates to a manufacturing method of a mask plate, more particularly, to a mask plate for glue coating and a manufacturing method thereof.

2. Description of the Prior Art

A panel display device presenting advantages over thinness, energy saving, and non-radiation, has been widely used. The conventional panel display device mainly utilizes a liquid crystal display (LCD) and an organic light emitting display (OLED).

The OLED having characteristics like self-luminance, high brightness, wide viewing angle, high contrast, flexibility, and low power consumption, has been broadly concerned and broadly applied to a mobile phone screen plate, a computer monitor, color TV, etc, as a display mode for next generation in place of conventional LCDs gradually. A difference between the OLED and a conventional LCD is that the OLED arranges very thin organic material layer, rather than a backlight, on a glass substrate so that the organic material layer emits light when a current passes through.

Referring to FIG. 1 illustrating a conventional OLED device comprises a glass substrate 100, an OLED element 300 is on the glass substrate 100 and a cover board 500 adheres onto the glass substrate 100. The OLED element 300 is sealed in sealed space 105 formed by the glass substrate 100 and the cover board 500. The OLED element 300 comprises a transparent conductive layer 302 on the glass substrate 100, a hole transport layer (HTL) 304 on the transparent conductive layer 302, an emitting material layer (EML) 306 on the HTL 304, an electron transport layer (ETL) 308 on the EML 306 and a cathode 309 on the ETL 308. The transparent conductive layer 302 is an anode of the OLED and generally composed of indium tin oxide (ITO). External direct current (DC) voltage across the anode 309 and the cathode 302 drives electrons and holes to inject into the OLED element 300. And a so-called “electron-hole capture” occurs when the electrons and holes encounter and conjugate with each other in the EML 306. After molecules in the EML 306 are excited by external energy, on the one hand, electron spin and ground state electrons are in pair, it is singlet and releases fluorescence, and on the other hand, excited state electrons and ground state electron spin are not in pair but in parallel, it is triplet and releases phosphorescence. In a transition of the state position of the electrons from an excited high energy level to a steady energy level from power state, energy of the electrons releases in the way of light emission, for implementing a display function, or heat dissipation.

The EML and electrodes of the OLED element, however, are easily reacted with vapor or oxygen, therefore, there is restricted demand for packaging the EML-based OLED device as a display device. To implement commercial application, the demand for packaging the OLED element on lifetime is at least over 10,000 hours, that on vapor permeability is equal or lower than 10⁻⁶ g/m²/day, and that on oxygen permeability is equal or lower than 10⁻⁵ cc/m²/day (1 atm). Therefore, packaging is one of the most key procedures in the whole manufacturing process to affect product yield.

A common method for packaging is using UV glue and desiccant, but the faults are a longer process and lower producing efficiency. There is a new and developing method for packaging in usage of glass paste, and it mainly adopts spot gluing or screen plate printing to coat the glass paste on a cover board, adheres a glass substrate having an OLED element to the cover board and then dries to finish the packaging of the OLED element. There are flaws in the spot gluing, however, like lower speed, out of control over pressure leading to off-gluing, over-gluing or few-gluing, to result in lower packaging yield.

Referring to FIG. 2 illustrating a schematic diagram of using a screen plate to coat with glass paste, the screen plate is formed by a screen plate formed by a plurality of lateral fabrics 902 and a plurality of vertical fabrics 904, and a number of meshes are formed by two adjacent lateral fabrics 902 and the vertical fabrics 904. The number of the meshes depends on tension in need. And then it leaves the part of the screen plate which needs to be coated with glass paste but coats the part of the screen plate which needs no glass paste with glue 906 according to positions of coating glass paste in need.

Such method that coating with glass paste by a screen plate increases a coating speed, however, it also tends to break fabrics of the screen plate in a process resulting from tension of a plurality of fabrics to deviate from the position of coating area, to shorten the lifetime and to replace the screen plate at higher frequency. In addition, it enhances coating height to make a height adjustment harder because of a laminated cross formed by the lateral and vertical fabrics. Therefore, it not only increases a risk of damaging films or glasses but also usually leaves a cross mark on the glasses to defect an appearance because the laminated crosses in the screen plate are not in the same plane.

### SUMMARY OF THE INVENTION

An object of the present invention is to provide a mask plate for glue coating which has a simple structure, longer lifetime and enhances an effect of glue coating.

Another object of the present invention is to provide a manufacturing method of the mask plate for glue coating which has a simple process, longer lifetime and enhances an effect of glue coating.

According to the present invention, a mask plate for glue coating comprising a frame and a screen plate installed on the frame is provided. The screen plate made of sheet metal comprises an outer shield area, an inner shield area and a plurality of skeletons whose one side connecting with the inner shield area and the other side connecting with the outer shield area. The outer shield area, the inner shield area and the skeletons form a plurality of coating areas.

Furthermore, the sheet metal is stainless steel or metal alloy, thickness of the sheet metal is 0.02 mm˜0.5 mm, the metal alloy is iron-nickel alloy, and the frame is made of stainless steel.

Furthermore, the coating area is a hole formed by laser cutting or etching.

Furthermore, a width of the skeletons is 5 mm-˜50 mm.

Furthermore, the screen plate is set up on the frame by laser welding, and the glue is glass paste.

According to the present invention, a method of manufacturing a mask plate for glue coating comprises the following steps:

Step 1: providing sheet metal and a frame;

Step 2: setting up a plurality of coating areas in the sheet metal, the plurality of coating areas dividing the sheet metal into two areas, inner shield area and outer shield area, each skeleton being formed between the any two adjacent coating areas for connecting the inner shield area and the outer shield area, and therefore a screen plate being made;

Step 3: arranging the screen plate on the frame to have the mask plate.

Furthermore, step 1 comprises washing unnecessary impurity out of the sheet metal, and step 2 comprises stretching the sheet metal, setting up the coating areas in the sheet metal as holes, and getting rid of burr of the sheet metal by chemical electropolishing.

Furthermore, the sheet metal is stainless steel or metal alloy, thickness of the sheet metal is 0.02 mm˜0.5 mm, the metal alloy is iron-nickel alloy, the frame is made of stainless steel, and a width of the skeletons is 5 mm˜50 mm.

Furthermore, the coating area is formed by laser cutting or etching.

Furthermore, the screen plate is set up on the frame by laser welding, and the glue is glass paste.

According to the present invention, a method of manufacturing a mask plate for glue coating comprises the following steps:

Step 1: providing sheet metal and a frame;

Step 2: setting up a plurality of coating areas in the sheet metal, the plurality of coating areas dividing the sheet metal into two areas, inner shield area and outer shield area, each skeleton being formed between the any two adjacent coating areas for connecting the inner shield area and the outer shield area, and therefore a screen plate being made;

Step 3: arranging the screen plate on the frame to have the mask plate;

wherein step 1 comprises washing unnecessary impurity out of the sheet metal, and step 2 comprises stretching the sheet metal, setting up the coating areas in the sheet metal as holes, and getting rid of burr of the sheet metal by chemical electropolishing;

wherein the sheet metal is stainless steel or metal alloy, thickness of the sheet metal is 0.02 m˜0.5 mm, the metal alloy is iron-nickel alloy, the frame is made of stainless steel, and a width of the skeletons is 5 mm˜50 mm;

wherein the coating area is formed by laser cutting or etching;

wherein the screen plate is set up on the frame by laser welding, and the glue is glass paste.

A benefit of the present invention is that the mask plate for glue coating and the manufacturing method thereof adopt a screen plate having coating areas and a shield area in one frame made of sheet metal so that it not only enhances the lifetime of the mask plate but also maintains a good appearance by preventing glasses from damage and cross marks during glue coating because the screen plate is in the same plane. Furthermore, it adjusts coating thickness to assure a packaging effect, to develop different processes and techniques and to lessen the thickness of the OLED device effectively by choosing different thick sheet metals to make the mask plate.

These and other objectives of the claimed invention will no doubt become obvious to those of ordinary skill in the art after reading the following detailed description of the preferred embodiment that is illustrated in the various figures and drawings.

### BRIEF DESCRIPTION OF THE DRAWINGS

The accompanying drawings are included to provide a further understanding of the invention, and are incorporated in and constitute a part of this specification.

FIG. 1 shows a diagram of a conventional OLED device.

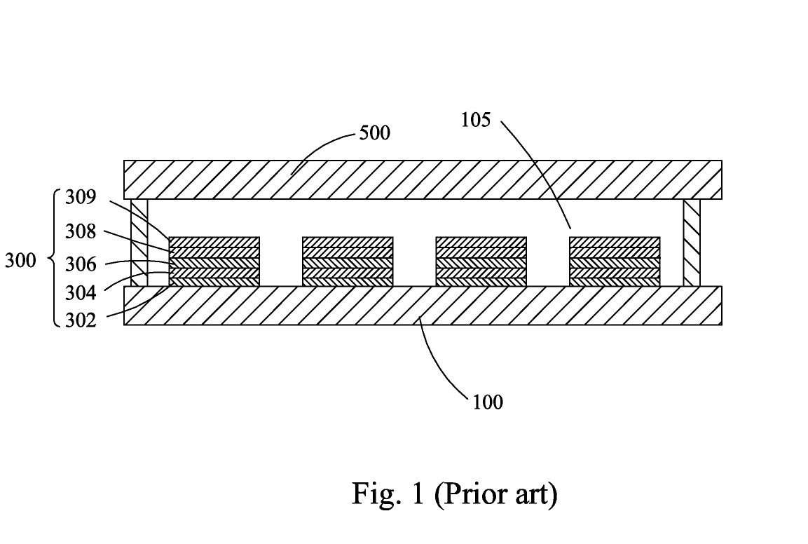

FIG. 2 shows a schematic diagram of a conventional screen plate for use in screen plate printing.

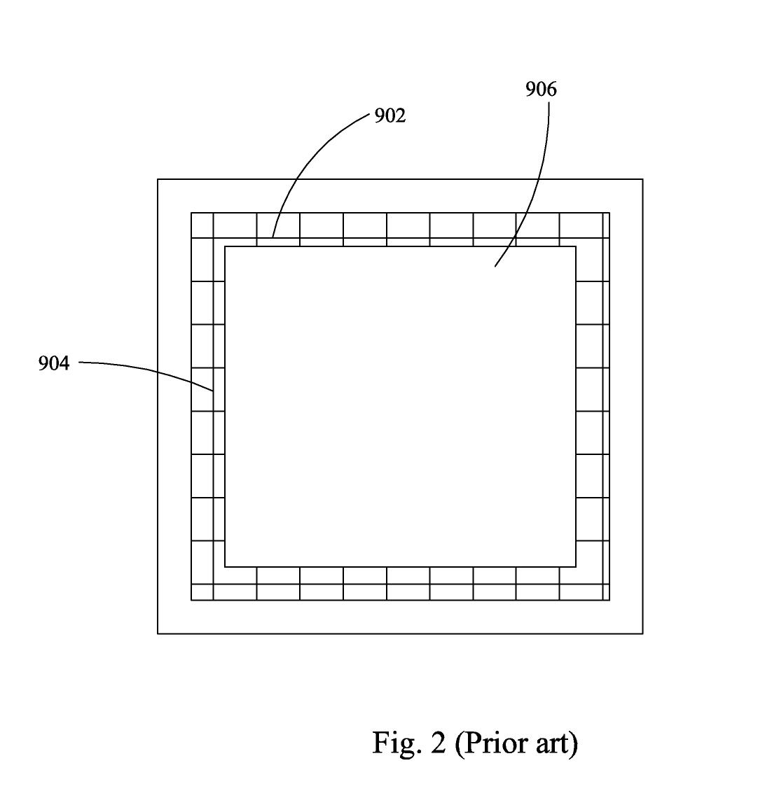

FIG. 3 shows a schematic diagram of a mask plate for glue coating according to a preferred embodiment of the present invention.

FIG. 4 shows a flowchart of a method of manufacturing a mask plate for glue coating according to a preferred embodiment of the present invention.

### DETAILED DESCRIPTION OF THE PREFERRED EMBODIMENTS

The drawings illustrate embodiments of the invention and, together with the description, serve to explain the principles of the invention.

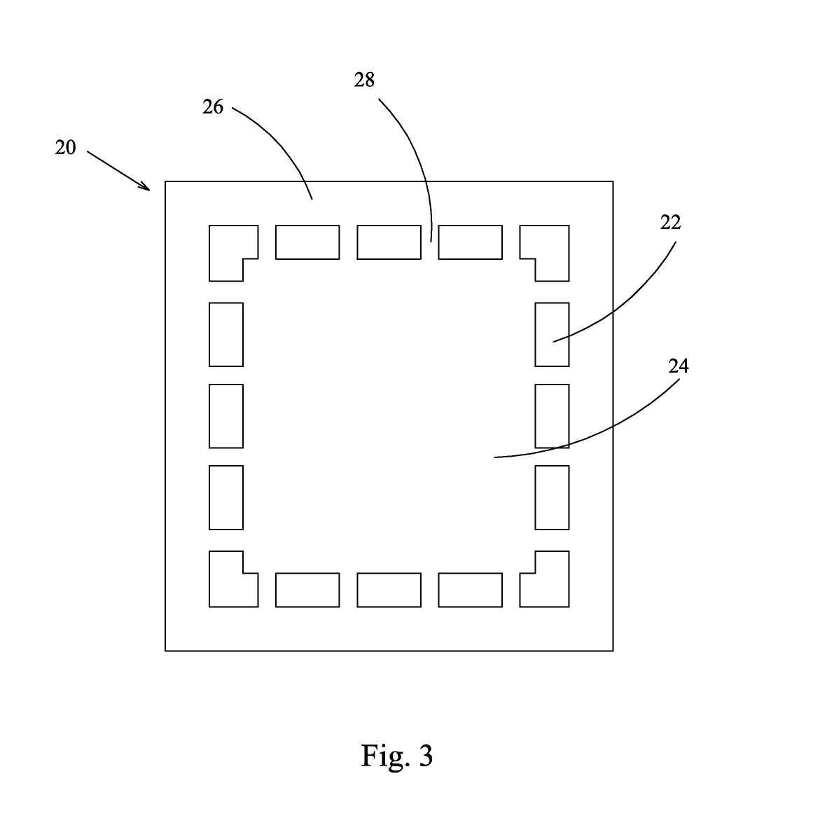

Referring to FIG. 3, the present invention provides a mask plate for glue coating comprising a frame (not shown) and a screen plate 20 installed on the frame and made of sheet metal. The screen plate 20 comprises an outer shield area 26, an inner shield area 24 and a plurality of skeletons 28 whose one side connecting with the inner shield area 24 and the other side connecting with the outer shield area 26. The outer shield area 26, the inner shield area 24 and the skeletons 28 form a plurality of coating area 22. Compared with the screen plate made of fabrics, the screen plate 20 made of sheet metals according to the present invention is stronger and therefore has longer lifetime and more stability.

The sheet metal is stainless steel or metal alloy so that it is good at rust prevention to prolong the lifetime of the mask plate. Preferably, the metal alloy is iron-nickel alloy. It is preferred that the sheet metal is SUS304, INVAR36 or other similar sheet metal. Besides that, it is capable of adjusting coating thickness to assure a packaging effect, to develop different processes and techniques and to lessen the thickness of the OLED device effectively by choosing different thick sheet metals. The thickness of the sheet metal of the embodiment is preferred to be 0.02 mm˜0.5 mm.

The coating area 22 is substantially a hole on the sheet metal by laser cutting or etching, and therefore the screen plate 20 is in the same plane. In hence, the screen plate 20 does not break films or glasses, not leave cross marks to maintain a good appearance, and prevents from defective products in the technical process to enhance quality of the OLED device during glue coating.

A number of the skeletons 28 depends on the tension of the screen plate 20 in need and a width of the skeleton 28, and the preferred width of the skeletons 28 is 5 mm˜50 mm. In the embodiment, a number of the skeletons 28 is 16, and the 16 skeletons 28 are set up evenly and symmetrically so that it maintains stability of the screen plate 20 well.

The frame made of stainless steel is light and rigid. The screen plate 20 is fixed on the frame by laser welding.

The glue of the embodiment is glass paste for a packaging of the OLED device. Application of the glue coating with the mask plate results in not only enhancing producing efficiency to lower cost but also lessening defective products in the technical process to improve product quality. In addition, the mask plate is not only used for glue coating OLED devices with glass paste in packaging but also for processes of glue coating in other business like touch panel.

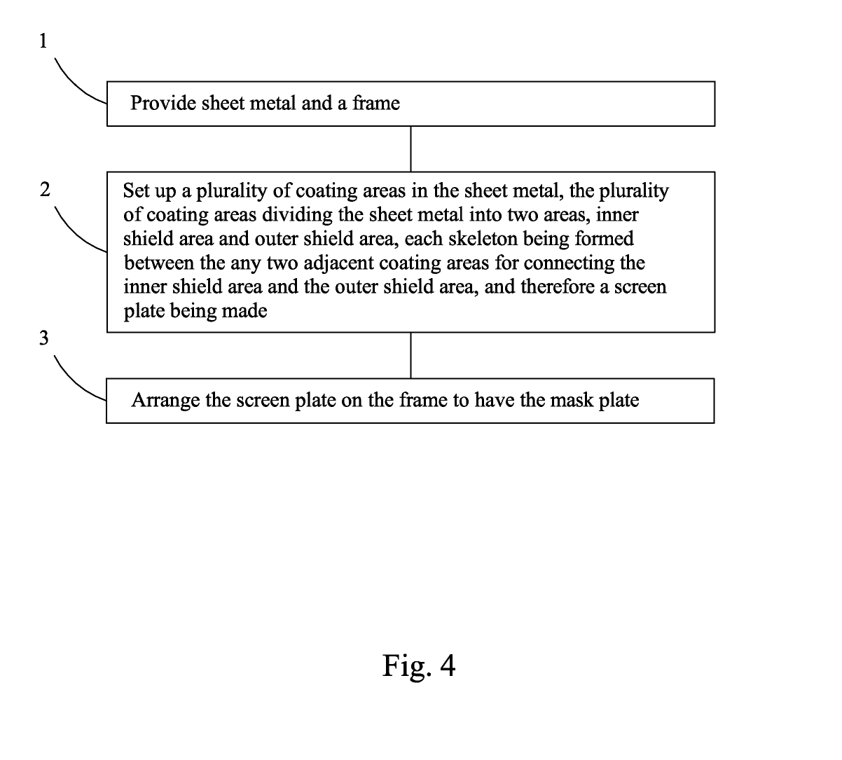

Referring to FIG. 3 and FIG. 4, the present invention further provides a manufacturing method of a mask plate for glue coating, and the method comprises the following steps:

Step 1: providing sheet metal and a frame.

In particular, take a stainless steel or metal alloy in larger size than that in need for a characteristic of rust prevention to prolong the lifetime of the mask plate. Preferably, the metal alloy is iron-nickel alloy. It is preferred that the sheet metal is SUS304, INVAR36 or other similar sheet metal. Wash unnecessary impurity out of the sheet metal. The frame made of stainless steel is light and rigid.

Step 2: arranging a plurality of coating areas 22 in the sheet metal, and the plurality of coating areas 22 divides the sheet metal into two areas, inner shield area 24 and outer shield area 26. Each skeleton 28 is formed between the any two adjacent coating areas and used for connecting the inner shield area 24 and outer shield area 26. Therefore, a screen plate 20 is made.

In particular, it stretches the sheet metal and cuts or etches the part of sheet metal in need of glue coating by laser cutting or etching to form a plurality of glue coating areas 22 according to the chosen substance and desired flatness in use. The tension is adjustable in need. The plurality of coating areas 22 divides the sheet metal into two areas, inner shield area 24 and outer shield area 26. Each skeleton 28 is formed between the any two adjacent coating areas for connecting the inner shield area 24 and outer shield area 26 to prevent all inner sheet metal (inner shield area 24) from dropping off. A number of the skeletons 28 depends on the tension of the screen plate 20 in need and the width of the skeleton 28 in need, and the number and width of the skeletons 28 do not influence glue coating effects. The width of the skeleton 28 is preferred to be 5 mm˜50 mm. It gets rid of burrs of the sheet metal to make fringe of the sheet metal and that of the coating areas 22 smooth by chemical electropolishing.

The screen plate 20 does not break films or glasses, not leave cross marks to maintain a good appearance, and prevents from defective products in the technical process to enhance quality of the OLED device during glue coating since the screen plate 20 manufactured in Step 2 is in the same plane.

In the embodiment, a number of the skeletons 28 is 16, and the 16 skeletons 28 are set up evenly and symmetrically so that it maintains stability of the screen plate 20 well.

Step 3: arranging the screen plate 20 on the frame 20 to obtain a mask plate.

In particular, the screen plate 20 adheres to the stainless steel frame by laser welding after the screen plate 20 corresponds to the stainless steel frame. And then it cuts the part of the sheet metal of the screen plate 20 over the frame off to form the final mask plate for glue coating.

It is noted that it is capable of adjusting coating thickness to assure a packaging effect, to lessen the thickness of the OLED device effectively and to develop different processes and techniques by using different thick sheet metals. The minimum of coating thickness is 0.004 mm˜0.006 mm, and the thickness of the sheet metal of the embodiment is preferred to be 0.02 mm˜0.5 mm.

The glue of the embodiment is glass paste for a packaging of the OLED device. The mask plate produced in such method results in not only enhancing producing efficiency to lower cost but also lessening defective products in the technical process to improve product quality. In addition, the mask plate is not only used for glue coating OLED devices with glass paste in packaging but also for processes of glue coating in other business like touch panel.

In sum, the mask plate according to the present invention for glue coating and the manufacturing method thereof adopt a screen plate, made of sheet metal, having coating areas and shield areas in one frame so that it not only enhances the lifetime of the mask plate but also maintains a good appearance by preventing glasses from damage and cross marks during glue coating because the screen plate is in the same plane. Furthermore, it adjusts coating thickness to assure a packaging effect, to develop different processes and techniques and to lessen the thickness of the OLED device effectively by choosing different thick sheet metals to make the mask plate.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A mask plate for glue coating comprising a frame and a screen plate installed on the frame, the screen plate made of sheet metal comprising an outer shield area, an inner shield area and a plurality of skeletons whose one side connecting with the inner shield area and the other side connecting with the outer shield area, and the outer shield area, the inner shield area and the skeletons form a plurality of coating areas.

2. The mask plate for glue coating of claim 1, wherein the sheet metal is stainless steel or metal alloy, thickness of the sheet metal is 0.02 mm˜0.5 mm, the metal alloy is iron-nickel alloy, and the frame is made of stainless steel.

3. The mask plate for glue coating of claim 1, wherein the coating area is a hole formed by laser cutting or etching.

4. The mask plate for glue coating of claim 1, wherein a width of the skeletons is 5 mm˜50 mm.

5. The mask plate for glue coating of claim 1, wherein the screen plate is set up on the frame by laser welding, and the glue is glass paste.

6. A method of manufacturing a mask plate for glue coating comprising the following steps:
Step 1: providing sheet metal and a frame;
Step 2: setting up a plurality of coating areas in the sheet metal, the plurality of coating areas dividing the sheet metal into two areas, inner shield area and outer shield area, each skeleton being formed between the any two adjacent coating areas for connecting the inner shield area and the outer shield area, and therefore a screen plate being made;
Step 3: arranging the screen plate on the frame to have the mask plate.

7. The method of manufacturing the mask plate for glue coating of claim 6, wherein step 1 comprises washing unnecessary impurity out of the sheet metal, and step 2 comprises stretching the sheet metal, setting up the coating areas in the sheet metal as holes, and getting rid of burr of the sheet metal by chemical electropolishing.

8. The method of manufacturing the mask plate for glue coating of claim 6, wherein the sheet metal is stainless steel or metal alloy, thickness of the sheet metal is 0.02 mm˜0.5 mm, the metal alloy is iron-nickel alloy, the frame is made of stainless steel, and a width of the skeletons is 5 mm˜50 mm.

9. The method of manufacturing the mask plate for glue coating of claim 6, wherein the coating area is formed by laser cutting or etching.

10. The method of manufacturing the mask plate for glue coating of claim 6, wherein the screen plate is set up on the frame by laser welding, and the glue is glass paste.

11. A method of manufacturing a mask plate for glue coating comprising the following steps:
Step 1: providing sheet metal and a frame;
Step 2: setting up a plurality of coating areas in the sheet metal, the plurality of coating areas dividing the sheet metal into two areas, inner shield area and outer shield area, each skeleton being formed between the any two adjacent coating areas for connecting the inner shield area and the outer shield area, and therefore a screen plate being made;
Step 3: arranging the screen plate on the frame to have the mask plate;
wherein step 1 comprises washing unnecessary impurity out of the sheet metal, and step 2 comprises stretching the sheet metal, setting up the coating areas in the sheet metal as holes, and getting rid of burr of the sheet metal by chemical electropolishing;
wherein the sheet metal is stainless steel or metal alloy, thickness of the sheet metal is 0.02 mm˜0.5 mm, the metal alloy is iron-nickel alloy, the frame is made of stainless steel, and a width of the skeletons is 5 mm˜50 mm;
wherein the coating area is formed by laser cutting or etching;
wherein the screen plate is set up on the frame by laser welding, and the glue is glass paste.
